(19) United States
(12) Patent Application Publication
(10) Pub. No.: US 2008/0199290 A1
(43) Pub. Date: Aug. 21, 2008

(54) Refuse and Recycling Collection System

(76) Inventor: Edward A. Traylor, Scottsboro, AL (US)

Correspondence Address: LANIER FORD SHAVER & PAYNE P.C., P O BOX 2087, HUNTSVILLE, AL, 35804-2087, US

(21) Appl. No.: 12/033,510

(22) Filed: Feb. 19, 2008

Related U.S. Application Data
(60) Provisional application No. 60/890,373, filed on Feb. 16, 2007.

(51) Int. Cl. B65F 3/04

(52) U.S. Cl. 414/408

(57) ABSTRACT

A refuse and recycling collection system for use with a vehicle that collects both refuse and recyclable materials configured with a grapple arm for grabbing, lifting and inverting a waste bin that has a hinged lid. The apparatus includes a movable retention member extending upwardly from the grapple arm for the selective retention of the hinged lid while the grapple arm holds the waste bin. The waste bin is configured with a first compartment for the containment of refuse, and a second compartment adjacent said at least one side wall for the containment of recyclable materials.

### CROSS REFERENCE TO RELATED APPLICATION

This application claims priority to U.S. Provisional Application No. 60/890,373, entitled “Refuse Collection System,” filed on Feb. 16, 2007, which is incorporated herein by reference.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts an exemplary refuse/recycling collection vehicle;

FIG. 2A depicts an exemplary waste bin modified to include one embodiment of a recycling bin receiver assembly;

FIG. 2B illustrates an embodiment of a recycling bin receiver assembly;

FIG. 2C is an elevational front view of an exemplary recycling bin receiver assembly;

FIG. 2D is an elevational side view of an exemplary recycling bin receiver assembly;

FIG. 2E is an elevational side view of another embodiment of an exemplary recycling bin receiver assembly;

FIG. 3A illustrates an exemplary grapple adapted to include one embodiment of a thumb apparatus;

FIG. 3B is a perspective view of the exemplary grapple of FIG. 3A with the thumb extended;

FIG. 3C is a perspective view of the exemplary grapple of 3A with the thumb lowered;

FIG. 4A is a front elevation view of an embodiment of the thumb;

FIG. 4B is a side elevation view of an embodiment of the thumb; and

FIG. 5 is a perspective view of an alternative embodiment of the thumb.

### DETAILED DESCRIPTION

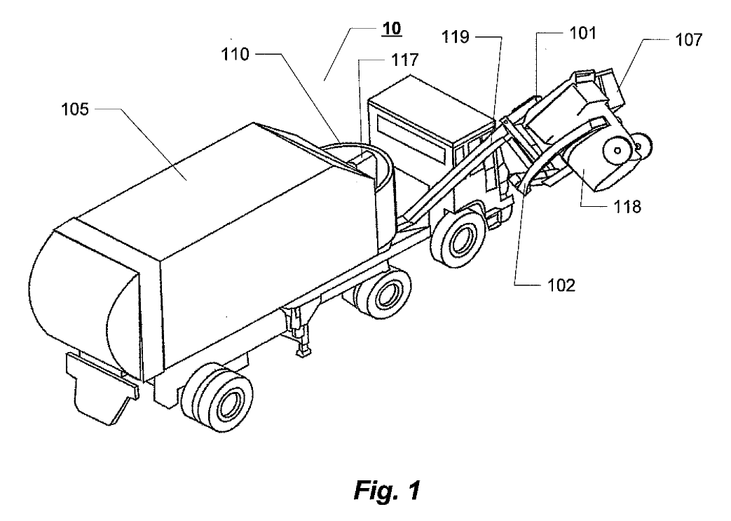

The various embodiments of the present invention and their advantages are best understood by referring to FIGS. 1 through 5 of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment. Moreover, features described with respect to a particular embodiment may also be employed in other disclosed embodiments as those skilled in the relevant arts will appreciate. This invention may be provided in other specific forms and embodiments without departing from the essential characteristics as described herein. The embodiments described below are to be considered in all aspects as illustrative only and not restrictive in any manner.

FIG. 1 illustrates an exemplary refuse/recycling truck 10 with which an embodiment of the present invention may be implemented. In this embodiment, truck 10 is of the type that is designed to pick up and transport refuse material, such as municipal garbage and trash, as well as materials offered for recycling, such as, without limitation, plastic articles, aluminum products, paper. Such a truck generally comprises two internal compartments (not shown) in its cargo area 105 and a common material receiving area 110 for receiving both refuse and recycling materials. The common receiving area 110 typically includes a means for diverting the material into the appropriate compartment. For example, the truck 10 of FIG. 1 includes a common receiving area 110 with a sweeping diverter plate 117. The diverter plate 117 in this exemplary truck may be initially commanded to a first position which closes off a first opening to one of the compartments, for example, the compartment in which refuse is carried. Then, when it is desired to collect recycling materials, recycling materials are poured into the receiving area 110. Then diverter plate 117 is commanded to sweep to the opposite side of the receiving area 110, pushing ahead of it any recycling material on the floor of the receiving area 110 into the compartment for recycling material and closing off the opening to that compartment and leaving open the compartment for refuse. Next, when it is desired to collect refuse, refuse material is dumped into the receiving area 110 and the diverter plate 117 may be swept back across the receiving area 110 to push the refuse materials into the refuse compartment.

One example of this type of equipment is known as the “Rapid Rail Co-Collector” offered by Heil Environmental Industries, Ltd, of Chattanooga, Tenn. There are other examples of collection vehicles that collect and transport more than one category of discarded materials (e.g., refuse, recycling materials, and yard waste, or the like). Some of these examples are described the following U.S. Pat. References: U.S. Pat No. 6,655,894 to Boivin, entitled Refuse collection Vehicle with Dual Storage Chute System; U.S. Pat. No. 5,205,698 to Mezey, entitled Waste Collection System for Segregating Solid Waste into Preselected Component Materials; U.S. Pat. No. 5,035,564 to Matsumoto, entitled Truck Body Construction for Separate Handling of Re-cyclable Refuse. Another type of multi-compartment collection vehicle with which embodiment of the apparatus disclosed herein may be implemented is that described in U.S. Pat. No. 5,222,853 to Carson, and entitled System and Apparatus for Automatic Collection of Recyclable Materials. All of the above patent references are incorporated by reference herein.

Referring back to FIG. 1, truck 10 includes an exemplary retrieving arm 119 with a clam-shell type grapple 102. Grapple 102 has been modified to include a thumb member 101 which will be described in greater detail below. Grapple 102 is designed to retrieve and enable the elevation and inversion of a modified waste bin 118 and recycling bin 107 in combination. Movement of retrieving arm 119 is actuated using either hydraulic or pneumatic power, as would be appreciated by those skilled in the art.

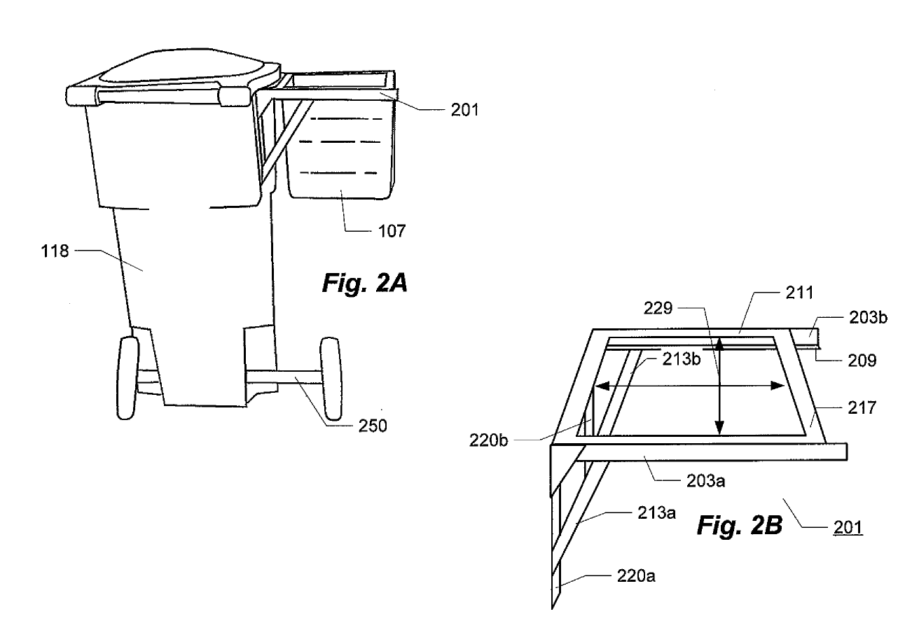

Referring now to FIGS. 2A through 2E, waste bin 118, as disclosed above includes a receiver assembly 201 for mounting a recycling material bin 107 thereto. If necessary, waste bin 118 may be modified to have an extended axle 250 which extends from the base of the waste bin 118 on the same side on which receiver assembly 201 is mounted to prevent the bin from tipping sideways when the attached recycling material bin 107 is full. It will understood by those skilled in the relevant arts that waste bins 118 may be configured with a wider base in order to support the additional weight of a fill recycling bin, instead of configuring the waste bin 118 with an extended axle.

Receiver assembly 201 comprises a frame 211 that is oriented generally horizontally and includes a horizontal top surface 217 within which is an opening 229. Lateral walls 203a, b extend downwardly from the top surface 217 and each wall includes a lip 209 that extends inwardly from the lower edge of the wall 203a, b. The frame walls 203a, b and lips 209 form a slot (FIG. 2C 219) for receiving and holding a recycling bin 107 of the type having outward-tending lips extending from a top rim that engage and rest upon the inward-tending lips 209 of the receiver assembly 201. Further, frame walls 203 and inward lips 209 may extend horizontally beyond top surface 217 of frame 211. Opening 229 is preferably dimensioned to be the same shape and no greater than the area of the opening of a recycling bin which is carried by the receiver assembly.

Assembly 201 also includes generally vertical members 220a, b by which assembly may be attached to waste bin 118. Attachment to waste bin 118 may be achieved with suitable fasteners. For additional support, assembly 201 includes brace members 213a, b attached at one end to vertical members 220a, b and at the other to walls 203a, b.

In an alternative embodiment, assembly may include a bar 225 that ties vertical members together in parallel. In another embodiment, vertical members 220a, b may be a single vertical member to which the frame and brace members are attached. In yet another embodiment, vertical members may be three or more vertical members tied in parallel with one or more tie bars as would be understood by those skilled in the art.

A further embodiment of assembly is discussed with reference to FIG. 2E, wherein vertical member(s) 221 are “inverted u”-shaped. Thus, the vertical member(s) 221 may hook over the wall waste bin 118. Fasteners may be used in addition to secure vertical member(s) 221 to the wall of the waste bin 118.

It will be recognized that receiver assembly 201 may be fabricated by attaching separate pieces together by welding. In that case, receiver assembly 201 could be formed from a plurality of steel members, including bars, and angles. Alternatively, receiver could be formed from casting as one piece using any suitable material, for example and without limitation, metals, including steel and aluminum, plastics, including polystyrene, High-Density Polyethylene (HDPE), ultra-high molecular weight polyethylene (UHMWPE) and other suitable polymerics. Of course, a combination of casting and assembly may also be used as would be appreciated by those skilled in the relevant arts.

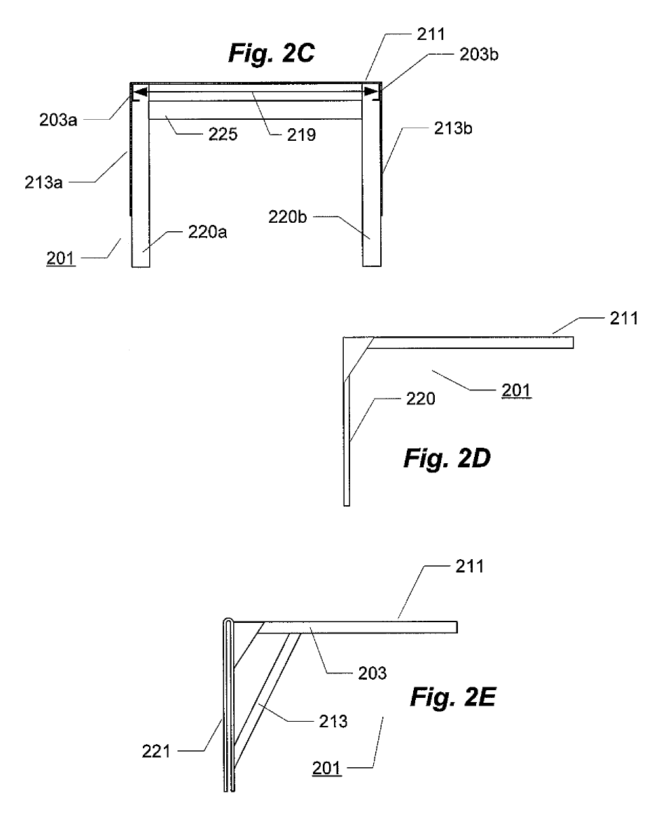

Turning to FIGS. 3A-C, as discussed above, grapple 102 is a clam-shell type grapple having two opposing claw arms 310, 311 and that is modified to include a generally vertical “thumb” member 101. In one exemplary embodiment, thumb member 101 is articulated and is comprised of two or more arms 303a, b pivotally connected by one or more joints 306. The number of arms and joints are a design choice as would be understood by those skilled in the relevant arts.

The lowermost arm 303b may be generally vertical extending upwardly from the grapple arm terminus 308. The figures depict an embodiment in which a grapple 102 has been modified to include the thumb assembly 101. Thus, lower arm 303b includes a “c” hook 305 at its bottom end, shaped to fit on the inward portion the grapple terminus 308 with respect to the grapple 102. The “c” hook includes flanges through which apertures are disposed. These apertures correspond to apertures formed in the grapple terminus and through which fasteners are inserted to hold the lower arm, and thus, the thumb assembly, to the grapple. It should be noted, however, that grapple 102 may be manufactured with the lower arm 303b extending upwardly therefrom as a unitary piece.

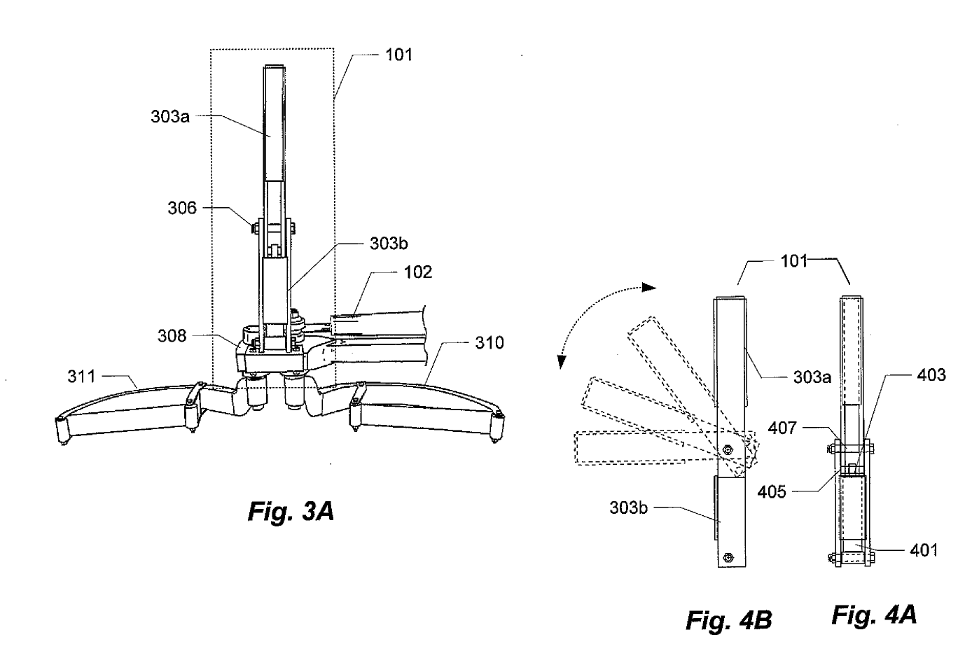

FIGS. 4A, B illustrate the thumb assembly 101, and the articulation of the arms in detail, showing a hydraulic actuator 401 housed within lower arm 303b. Hydraulic actuator 401 imparts axial force to piston arm 403 the exposed, uppermost, end of which is pivotally connected to a first trunnion 405 mounted within the lower end of upper arm 303a. A second trunnion 407 pivotally connects the upper arm 303a, to the upper end of the lower arm 303b in a lever manner. In lowering the upper arm 303a, actuator 401 imparts force to piston arm 405 which extends from actuator and imparts force on the first trunnion 405 in the lower end of the upper arm 303a. This causes the lower end of the upper arm 303a to rise, and the upper end thereof to lower. (FIG. 4B).

In operation, truck 10 retrieves a waste bin 118 that has been modified to include the recycling bin receiver assembly 201. Claw arms 310, 311 extend about and encase the waste bin 118. Upper arm 303a of thumb 101 is lowered to hold down the lid of the waste bin 118 and the waste bin 118 combined with the recycling bin 107 held in the receiver assembly 201 is raised, brought to a point over the receiver area 110 and inverted. Contents of the recycling bin 107 are emptied into the receiver area 110 and the diverter plate 117 is commanded to sweep to the opposing side of the receiver area 110 and push the recycling material into the appropriate compartment. Retrieving arm 119 is lowered, the waste bin 118 is turned upright, and the thumb 101 upper arm 303a is raised, releasing the lid of the waste bin 118. The waste bin 118 is then lifted again and inverted, this time emptying the contents of the waste bin 118, i.e., refuse, into the receiving area 110 to be pushed in the refuse compartment of the truck 10.

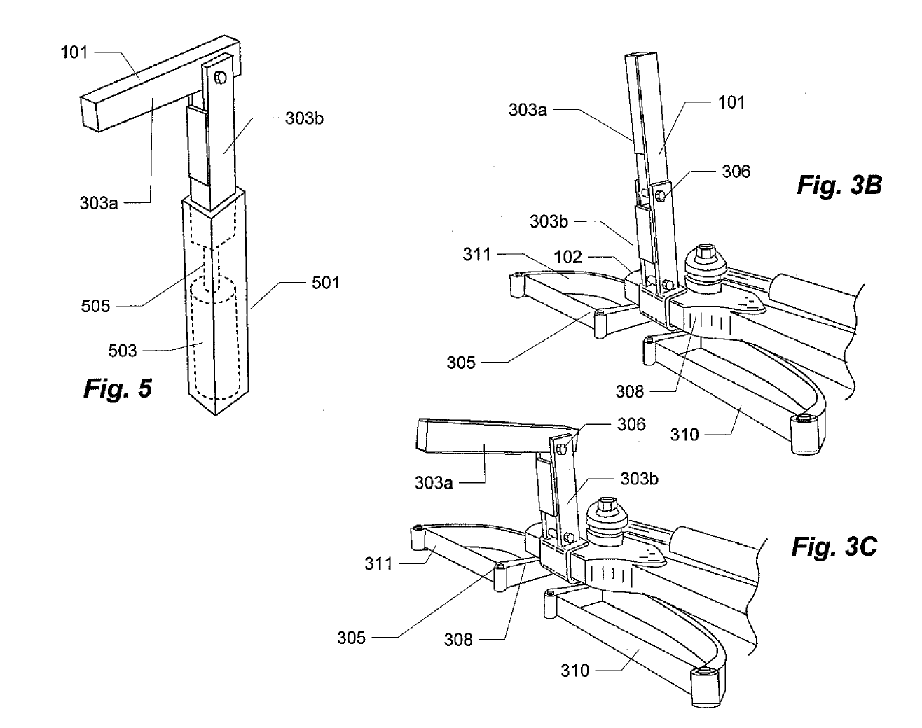

A further embodiment is described with reference to FIG. 5. In this embodiment, a generally vertical hollow stanchion 501 houses a hydraulic actuator 503 that imparts axial force, generally vertically, to a piston arm 505. Both the actuator 503 and the piston arm 505 are indicated in the FIG. 5 by dashed lines. Piston arm 505 extends from actuator 503 and has a terminal end attached to lower arm 303b of thumb 101. Stanchion 501 and lower arm 303b are dimensioned so that lower arm 303b may be slidably received within stanchion 501. Upper arm 303a is pivotally connected to lower arm 303b as described above with reference to FIGS. 4A&B. Although not shown in the figure, stanchion is to be fixedly mounted to grapple arm terminus (308 of FIG. 3) similar to the manner in which lower arm 303b of FIG. 3 is attached to grapple arm terminus.

In operation, when the bin 118 is received in the claw arms of grapple 102, thumb 101 is in an extended position. As the claw arms encircle the bin, thumb 101 is retracted by actuation of the hydraulic actuator housed within stanchion. When the thumb 101 is retracted, the upper arm 303a is lowered as described above and contacts the lid of the bin 118, keeping it closed. The bin 118 may be raised, inverted and the contents of the recycling bin may be emptied in to the receiving area of the truck. The bin may be returned upright, the thumb 101 and upper arm 303a are extended which releases the lid. The bin may then be inverted again to empty the content of the bin 118 into the truck's receiving area.

Those skilled in the arts will appreciated that upper and lower arms may be fixedly connected so that the combination arm is not articulated, and the upper arm 303a does not pivotally raise and lower. In this case, it is preferable for upper arm 303a to be oriented generally horizontal or parallel with the ground. In addition, thumb 101 maybe a unitary generally “L”-shaped member.

The above disclosure describes, for illustration purposes only, the operation of the present invention with a unit such as the Heil® “Rapid Rail Co-Collector.” However, it will be appreciated that embodiments of the disclosed apparatus may be adapted for use with any vehicle designed to collect and transport multiple categories of disposed of materials where the vehicle includes a hydraulic grapple arm.

As described above and shown in the associated drawings, the present invention comprises refuse and recycling collection system. While particular embodiments of the invention have been described, it will be understood, however, that the invention is not limited thereto, since modifications may be made by those skilled in the art, particularly in light of the foregoing teachings. It is, therefore, contemplated that any claims issuing in an ensuing patent will cover any and all such modifications that incorporate those features or those improvements that embody the spirit and scope of the present invention.

What is claimed is:

1. In a refuse and recycling collection system, said collection system having a vehicle adapted to collect both refuse and recycling, the vehicle having a grapple arm for grabbing, lifting and inverting a waste bin, the waste bin having a hinged lid, an apparatus comprising:
a movable retention member extending upwardly from the grapple arm for the selective retention of the hinged lid while the grapple arm holds the waste bin;
wherein the waste bin is configured with a first compartment for the containment of refuse having at least one side wall, and a second compartment adjacent said at least one side wall for the containment of recyclable materials.

2. The apparatus of claim 1, wherein said second compartment comprises a receiver assembly attachable to said at least one side wall, said receiver assembly comprising:
a vertical attachment member attached to said side wall of said first compartment and having a top portion;
a horizontal frame portion extending laterally from said top portion of said vertical attachment member, said horizontal frame having a horizontal top planar portion defining an opening therein and opposing inward ledges along the front and rear periphery of said horizontal frame for receiving a bin for containing recyclable materials.

3. The apparatus of claim 2, wherein said retention member is articulated having a first arm extending upwardly from the grapple arm and a second arm pivotally connected at one end to the top of the first arm, wherein said second arm is selectively movable inwardly with respect to the grapple arm.

4. The apparatus of claim 2, wherein said retention member comprises a first arm extending upwardly from the grapple arm, and a second arm connected at one and to the top of the first arm, wherein said first arm is selectively movable vertically.
